(19) United States
(12) Patent Application Publication
(10) Pub. No.: US 2024/0174148 A1
(43) Pub. Date: May 30, 2024

(54) Vehicle Seat and Method of Assembling the Vehicle Seat Without Tools

(71) Applicant: GRAMMER Aktiengesellschaft, Ursensollen (DE)

(72) Inventors: Sebastian LINGL, Hahnbach (DE); Michael NIEBAUER, Oberviechtach (DE)

(73) Assignee: GRAMMER Aktiengesellschaft, Ursensollen (DE)

(21) Appl. No.: 18/473,447

(22) Filed: Sep. 25, 2023

(30) Foreign Application Priority Data
Nov. 25, 2022 (DE) 10 2022 131 302.6

(51) Int. Cl. B60N 2/68; B60N 2/20

(52) U.S. Cl. CPC B60N 2/68; B60N 2/20

(57) ABSTRACT

The invention relates to a vehicle seat having a seat part frame and a seat part which can be displaced in relation to the seat part frame, wherein the seat part is guided on the seat part frame by means of a guide means.

### CROSS REFERENCE TO RELATED APPLICATION

This application claims the benefit of German Patent Application No. 10 2022 131 302.6, filed Nov. 25, 2022, the contents of which are incorporated herein by reference in its entirety.

### FIELD

The invention relates to a vehicle seat having a seat part frame and a seat part which can be displaced in relation to the seat part frame, wherein the seat part is guided on the seat part frame by means of a guide means.

### BACKGROUND

Such vehicle seats are sufficiently known from the state of the art, which are formed in such a way.

These vehicle seats have a locking mechanism by means of which, when the locking mechanism is released, the vehicle seat can be displaced backwards or forwards, depending on the needs of the respective person.

However, these locking mechanisms are elaborately formed. Further, when the person stands up and leaves the vehicle seat, the vehicle seat remains in the currently set position. Particularly in the railway industry, these vehicle seats must then be manually returned to the basic position by a train attendant.

These vehicle seats are also difficult to assemble and may be extremely costly to repair.

### SUMMARY

Accordingly, it is the object of the present invention to overcome the disadvantages of the prior art. A vehicle seat is proposed which is of particularly simple construction and which automatically returns to the basic position after the vehicle seat has been abandoned. Furthermore, it is an object of the present invention to enable tool-free assembly or disassembly of the vehicle seat.

This object is solved on the one hand by a vehicle seat with the features of claim 1 and on the other hand by a method for tool-free assembly with the features of claim 9.

A core idea of the invention is to provide a vehicle seat with a seat part frame and a seat part which is displaceable in relation to the seat part frame, the seat part being guided on the seat part frame by means of a guide means. The seat part can be displaced in relation to the seat part frame from a basic position into a displaced position by a force acting on the seat part, which can be applied to the seat part by a person sitting on the seat part, the vehicle seat being formed and provided such that the seat part can be held in the displaced position by the weight of the person sitting on the seat part. A restoring element is formed and provided to shift the seat part from the displaced position to the basic position when the person leaves the seat part.

According to the invention, it is provided that the seat part can be displaced by an acting force, wherein the acting force is applied by a person sitting on the seat part. Such an acting force can act on the seat part or can be introduced into the seat part by a shift in the weight of the person. This allows a particularly simple displacement of the seat part adapted to the person with regard to the needs of the person.

Likewise, it is provided according to the invention that the seat part, after the seat part has been brought into the displaced position, is held in the displaced position solely by the weight of the person sitting on the seat part. This is in particular the case that according to the invention a restoring element is provided, but it is preferred that the (restoring) force acting on and provided by the restoring element is lower than the weight of the person, however it is also such that a restoring from the displaced position to the basic position takes place when the person leaves the seat part, that is when the weight force no longer acts on the seat part.

A displacement of the seat part to the seat part frame is preferably provided along a displacement direction. Particularly preferred is, the displacement direction a longitudinal direction of the vehicle seat.

Particularly preferred is, the autonomic restoring of the seat part, that is the displacement from the displaced position to the basic position. Manual displacement of the seat part is no longer necessary. Thus, especially in rail transport areas or the like, an attendant of the vehicle no longer needs to manually restoring the vehicle seat, which can mean a considerable reduction in workload and time savings.

It is particularly preferred that the restoring element is provided and formed to automatically shift the seat part from the displaced position to the basic position.

According to a preferred embodiment, it is provided that the restoring element is connected on the one hand to the seat part and on the other hand to the seat part frame. This makes it possible for the restoring element to cause a relative movement between the seat part and the seat part frame.

According to a further preferred embodiment, it can be provided that the restoring element comprises a first end and a second end, the first end being connected to the seat part and the second end being connected to the seat part frame. Further preferably, the first end and/or the second end may be rotatably connected to the seat part and the seat part frame, respectively. By leaving the seat part rigid and allowing the seat part to move relative to the seat part frame, this movement can be easily followed by a rotatable connection.

According to a preferred embodiment, it can be provided that the first end of the restoring element is connected to the seat part by means of a first spherical head element and/or the second end of the restoring element is connected to the seat part frame by means of a second spherical head element.

According to a particularly preferred embodiment, the restoring element can be of particularly simple construction if the restoring element is formed by a gas spring element. Particularly preferably, the gas spring element is substantially relaxed in the basic position and compressed in the displaced position.

The gas spring element preferably comprises a cylinder and a piston rod which is connected to the cylinder and which can be displaced relative to the cylinder.

In this context, substantially relaxed means that the gas spring element is approximately fully extended. This is the case when no force is acting on the gas spring element. However, due to the positioning of the return element, it is possible that a small residual distance remains, so that the restoring element still has free movement, so that the restoring element can still be moved slightly in the basic position of the vehicle seat. In other words, the restoring element still has a residual distance in the basic position until the gas spring element is in the fully relaxed position.

Particularly preferred is that the restoring element is elongated. Further preferably, the restoring element is arranged in the displacement direction, which corresponds, for example, to the longitudinal direction of the vehicle seat. This is particularly advantageous if the restoring element is formed as a gas spring element, so that the gas spring element can work and be compressed particularly well.

According to the invention, a guiding means is provided by means of which the seat part can be guided in relation to the seat part frame. Particularly preferably, the guide means is formed in such a way that the seat part can be displaced in the displacement direction.

According to a preferred embodiment, the guide device can be of particularly simple design if the guide device comprises groove elements and grooves, the groove elements being formed at least partially complementary to the grooves, so that the groove elements can be guided in the grooves.

It may be provided that the sliding block elements are connected, in particular firmly connected, to the seat part frame, and the slots are formed in the seat part. This can facilitate assembly of the seat part. Alternatively, it would also be conceivable that sliding block elements are connected, in particular fixedly connected, to the seat part, and the slots are build into the seat part frame.

The guide means can be formed in a particularly simple and structurally advantageous manner if one of the sliding block elements or each sliding block element comprises a first section, a second section and a third section, wherein the first section is arranged above the slot and is formed wider than the slot, and wherein the second section is connected to the first section and extends through the corresponding slot and a third section is arranged below the groove and is connected to the second section, wherein the third section is also formed wider than the groove.

The sliding block element thus preferably has a layered structure, formed by the first section, the second section and the third section, which are arranged one above the other in a height direction. By the fact that preferably the second section can be guided in the slot and the first section and the third section are formed wider than the groove, a loosening of the sliding block and the slot can be prevented.

Particularly preferred, the slot or the slots have a mounting section hare, which is formed and provided such that the first portion can be guided through this mounting section so that the second section can then protrude through the slot. Preferably, the mounting section is dimensioned such that the first section can be passed therethrough.

The slot is held in place by the first section and the third section, so that the sliding block can be well prevented from falling out of the slot.

Particularly preferred is the position of the mounting section or the displacement of the seat part is such that in an assembled state of the vehicle seat, that is, that the seat part is mounted on the seat part frame, the sliding block cannot be guided as far as the mounting section in order to be able to prevent the sliding block from falling out of the slot.

Particularly advantageously, according to a preferred embodiment, the falling out of a sliding block can be prevented and the displacement can be limited if a first end stop is arranged on the seat part and a bolt element is arranged on the seat part frame, which are provided and formed to interact with each other when the seat part is moved from the basic position into the displaced position, wherein contact of the bolt element with the end stop defines the displaced position, in particular the maximum displaced position.

Further preferably, it is advantageous if the first end stop is arranged in front of the mounting section in the displacement direction. This means that when the seat is displaced into the displaced position, it is not possible to displace the seat part so far that the sliding block is arranged in the mounting section.

The theoretically still available distance that can be covered from the maximum displaced position into the mounting section essentially corresponds to the remaining distance of the restoring element. In order to displace the seat part or the respective sliding block element into the mounting section, it is necessary that the bolt element is releasable from the first end stop so that the seat part can be displaced beyond the first end stop or the basic position (and vice versa) so that the seat part can be easily mounted or dismounted.

Particularly preferably, the displacement movement of the seat part in relation to the seat part frame can be further limited due to space constraints in the vehicle, for example a distance from the front seat, if a second end stop is arranged on the seat part, wherein in the basic position the second end is in contact with the second end stop and in the displaced position the second end is disengaged from the second end stop.

The second end stop is particularly preferably arranged in front of the first end stop, as seen in the displacement direction.

The underlying object is also solved by a method for tool-free assembly of the vehicle seat with the features of patent claim 9.

The method for tool-free assembly comprises at least the following method steps:
a) Providing a seat part frame and a seat part, wherein a restoring element is connected to the seat part,
b) connecting the seat part frame and the seat part by means of the guide means;
c) connecting the first end of the restoring element to the seat part frame.

Here, tool-free means in particular that a person assembling the vehicle seat does not require any aids such as tools to assemble the vehicle seat. The components of the vehicle seat, in particular the seat part and the seat part frame, can be connected to one another and disassembled without the use of auxiliary means.

According to a further preferred embodiment, assembly can be further facilitated if, in process step c), the first end is displaced in the height direction by means of the second end stop comprising a guide means, so that the first end can be connected to can be connected to the seat part frame.

The second end stop therefore serves not only as an end stop during use of the vehicle seat, but also as an aid for mounting the seat part to the seat part frame.

According to a further preferred embodiment, assembly can be facilitated if the first end stop, after process step b), is positioned in front of the bolt in the direction of displacement or in a longitudinal direction, respectively. of a longitudinal direction and the bolt element is not arranged to engage in the end stop, so that to set the basic position the bolt element is displaced downwards in a height direction, then the seat part is displaced in the longitudinal direction until the bolt element can engage in the end stop and the bolt element is displaced upwards in the height direction and the first end stop is contacted.

Further configuration and embodiments among the execution forms are applicable to the further executions and are freely combinable among each other, provided that they do not correspond to opposite execution. Features regarding the vehicle seat and the method for assembling the vehicle seat are usable in a corresponding manner.

Further advantageous execution form result from the subclaims.

The various execution form with all their features can be combined and interchanged as desired.

The applicant reserves the right to claim all features disclosed in the application documents as essential to the invention, provided that they are individually or in combination new compared to the prior art. It is further pointed out that the individual figures also describe features which may be advantageous in themselves. The expert person immediately recognizes that a certain feature described in a figure can also be advantageous without adopting further features from this figure.

Furthermore, the expert recognizes that advantages can also result from a combination of several features shown in individual figures or in different figures.

Further objectives, advantages and usefulness of the present invention are to be taken from the following description in connection with the drawings. Hereby shows:

### BRIEF DESCRIPTION OF THE DRAWINGS

The figures show:

FIG. 1A a vehicle seat in a side view in a basic position;

FIG. 1B the vehicle seat according to FIG. 1A in a front view;

FIG. 2A the seat part according to FIG. 1A;

FIG. 2B the seat part according to FIG. 2A in a bottom view;

FIG. 2C the seat part frame of the vehicle seat according to FIG. 1A;

FIG. 3 a section of the seat part frame of FIG. 2C;

FIGS. 4A-4C schematic of the principle of operation of the vehicle seat;

FIG. 5A a section of the seat part according to FIG. 2A with a restoring element;

FIG. 5B a side view of FIG. 5A;

FIG. 6A a section of the seat part and the seat part frame in the basic position;

FIG. 6B a section of the seat part and the seat part frame in the displaced position;

FIG. 7A-7C an assembly procedure;

FIG. 8A-8E a disassembly procedure.

### DETAILED DESCRIPTION

In the figures, identical components are to be understood with the corresponding reference signs. For the sake of clarity, in some figures components may not have a reference sign, but have been designated elsewhere.

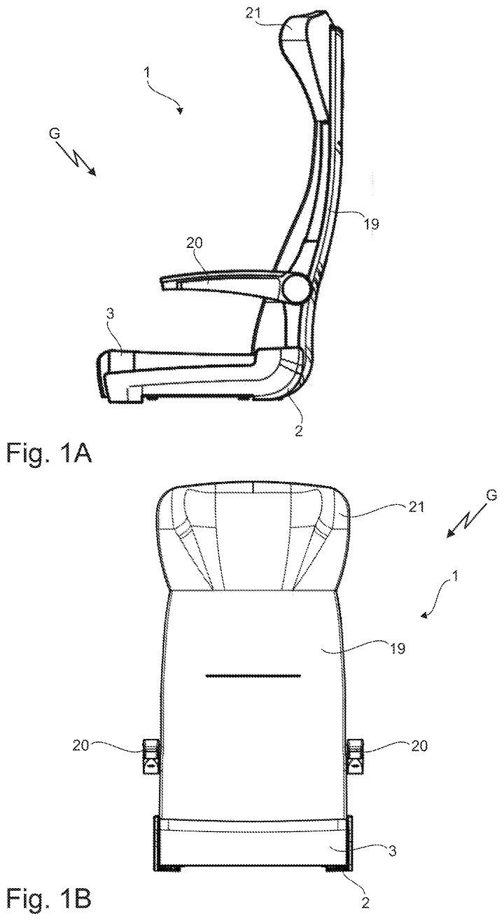

FIGS. 1A and 1B show a vehicle seat 1 according to the invention, the vehicle seat 1 being shown in a side view in FIGS. 1A and 1n a front view in FIG. 1B, in each case in a basic position G.

Further, the vehicle seat 1 may include a backrest 19, at least one armrest 20 pivotally connected to the backrest 19 rotatably connected to the backrest 19, and a headrest 21.

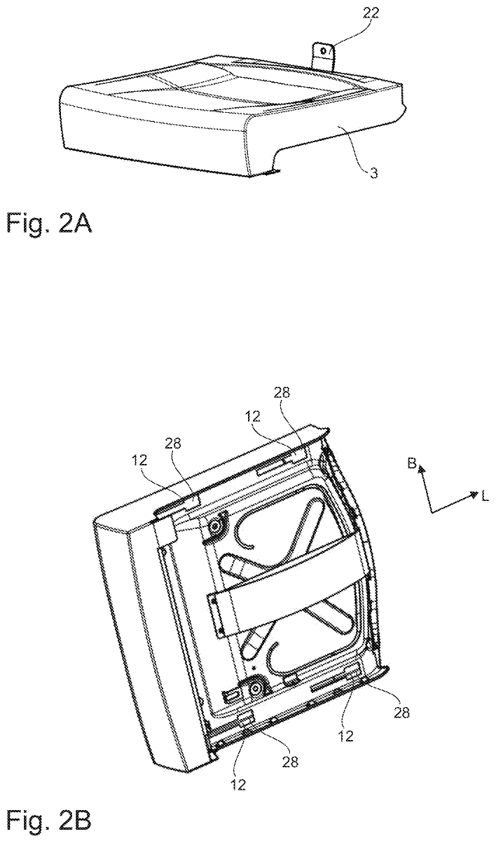

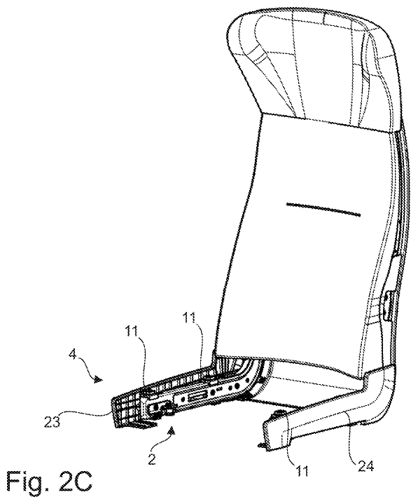

In FIG. 2A, the seat part 3 is shown separately. Particularly preferably, the seat part 3 has a mounting element 22 at a rear end, which can be connected to at least a part of the backrest 19. The mounting element 22 will be discussed in more detail in connection with the assembly or disassembly of the vehicle seat 1.

FIG. 2B shows the seat part 3 of FIG. 2A in a perspective view from below. It can be seen, for example, that the seat part 3 has slots 12, preferably two slots 12 being provided on the right and two slots 12 being provided on the left of the seat part 3, that is to say that the left-hand slots 12 and the right-hand slots 12 are spaced apart from one another in the width direction B. The two slots 12 on the respective side are further preferably arranged one behind the other, that is, spaced apart from each other in the longitudinal direction L.

In the assembled state of the vehicle seat 1, the slot 12 are in contact with sliding block elements 11, which are arranged on the seat part frame 2 and connected thereto. The arrangement of the sliding block elements 11 is analogous to the arrangement of the slots 12, so that each slot 12 can receive or contact a sliding block 11.

According to the invention, a guide means 4 is provided by means of which the seat part 3 can be guided relative to the seat part frame 2. Particularly preferably, the guide means 4 is formed in such a way that the seat part 3 can be displaced in the displacement direction.

According to a preferred embodiment, the guide means 4 can be particularly simply constructed if the guide means 4 comprises the sliding block elements 11 and the slots 12, wherein the sliding block elements 11 are formed at least partially complementary to the slots 12, so that the sliding block elements 11 can be guided in the slots 12.

As shown in FIGS. 2B and 2C, the sliding block elements 11 are connected, in particular fixedly connected, to the seat part frame 2, and the slots 12 are formed in the seat part 3. This can facilitate the assembly of the seat part 3, which will be explained further with regard to subsequent figures.

Further preferably a first cover element 23 and a second cover element 24 are shown, which are connected to the seat part frame 2, preferably detachably connected, and which cover the seat part frame 2 to the outside, so that an engagement of fingers in the guide means 4 is not possible during the displacement.

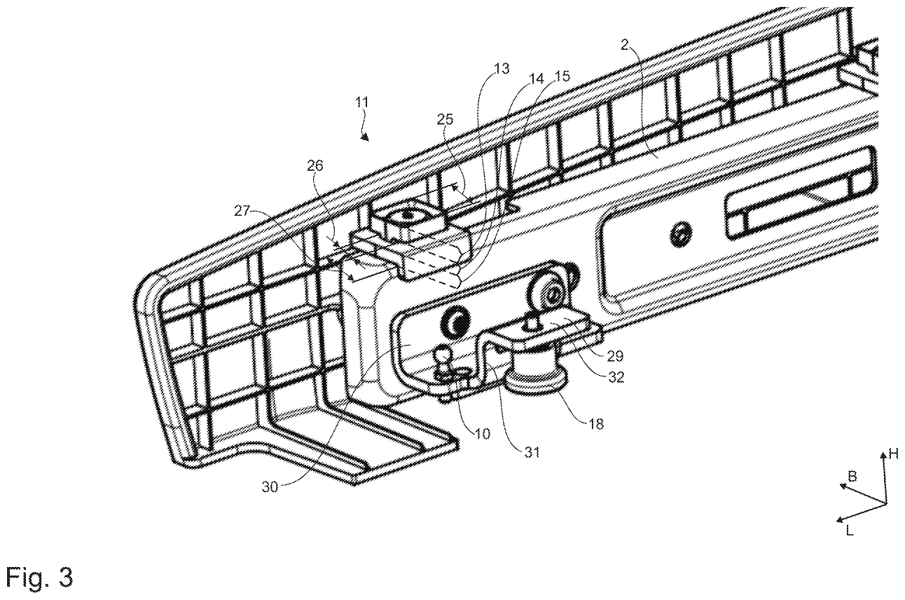

The guide means 4 can be formed in a particularly simple and structurally advantageous manner if one of the sliding block elements 11 and/or each sliding block element 11 comprises a first section 13, a second section 14 and a third section 15, wherein preferably the first section 13 is arranged above the slot 12 and is formed wider than the slot 12, and wherein preferably the second section 14 is connected to the first section 13 and extends through the corresponding slot 12 and a third section 15 is arranged below the slot 12 and is connected to the second section 14, wherein the third section 15 is also formed wider than the slot 12. This is particularly well seen in further FIG. 3, in which a portion of FIG. 2C is shown enlarged.

Particularly preferred is that the second section 14 is formed complementary to the slot 12 at least in the width direction B. The second section 14 has a second width 26. Further preferably, the first section 13 has a first width 25 and the third section 15 has a third width 27, which are each formed larger than the second width 26 and larger than the width of a slot 12. This allows the slot 12 to be well displaced in relation to the sliding block element 11, resulting in a good displacement of the entire seat part 3 relative to the seat part frame 2.

The sliding block element 11 thus preferably has a layered structure, formed by the first section 13, the second section 14 and the third section 15, which are arranged one above the other in a height direction H. Due to the fact that preferably the second section 14 can be guided in the slot 12 and the first section 13 and the third section 15 are formed wider than the slot 12, a loosening of the sliding block element 11 and the slot 12 can be prevented.

Particularly preferably, the slot 12 or the slots 12 have a mounting section 28 which is formed and provided to allow the first portion 13 to be guided through this mounting section 28 so that the second section 14 can then project through the slot 12. Preferably, the mounting section 28 is dimensioned such that the first section 13 can be passed therethrough.

The slot 12 is held in place by the first section 13 and the third section 15, so that the sliding block element 11 can be well prevented from falling out of the slot 12.

Particularly preferably, the position of the mounting section 28 or the displacement of the seat part 3 is such that in an assembled state of the vehicle seat 1, that is to say that the seat part 3 is mounted on the seat part frame 2, the sliding block element 11 cannot be guided as far as the mounting section 28 in order to be able to prevent the sliding block element 11 from falling out of the slot 12.

Particularly advantageously, according to a preferred embodiment, the falling out of a sliding block element 11 can be prevented and the displacement can be limited if a first end stop 16 is arranged on the seat part 3 and a bolt element 18 is arranged on the seat part frame 2, which bolt elements are provided and formed to interact with each other when the seat part 3 is moved from the basic position G into the displaced position V, wherein contacting the bolt element 18 with the first end stop 16 can define the (maximum) displaced position V. Particularly preferably, the bolt element 18 can be displaced in the height direction H such that the connection between the bolt element 18 and the first end stop 16 can be released.

Further preferably, it is advantageous if the first end stop 16 or the bolt element 18 is arranged in front of the mounting section 28 in the displacement direction. This means that when the seat part 3 is displaced to the basic position G, it is not possible to displace the seat part 3 to such an extent that the sliding block 11 is arranged in the mounting section 28. In this way, unintentional detachment of the seat part 3 from the seat part frame 2 can be effectively prevented.

Further preferably, a first retaining element 29 is provided, which can be arranged on the seat part frame 2 and connected thereto. Preferably, the first retaining element 29 carries the bolt element 18. Further preferably, the first retaining element 29 can have or carry a connection for the restoring element 5, represented here by a second spherical head element 10.

Particularly preferably, the first retaining element 29 partially has a U-shaped configuration with a first leg 30, which is preferably arranged on the seat part frame 2, and with a second leg 31, which is spaced apart from the first leg 30 in the width direction B. The second leg 31 preferably is connected to a horizontal retaining piece 32, on which the bolt element 18 can be arranged. Due to the U-shaped design of the first retaining element 29, the restoring element 5 can be accommodated particularly well in the U-section, so that a space saving is the result.

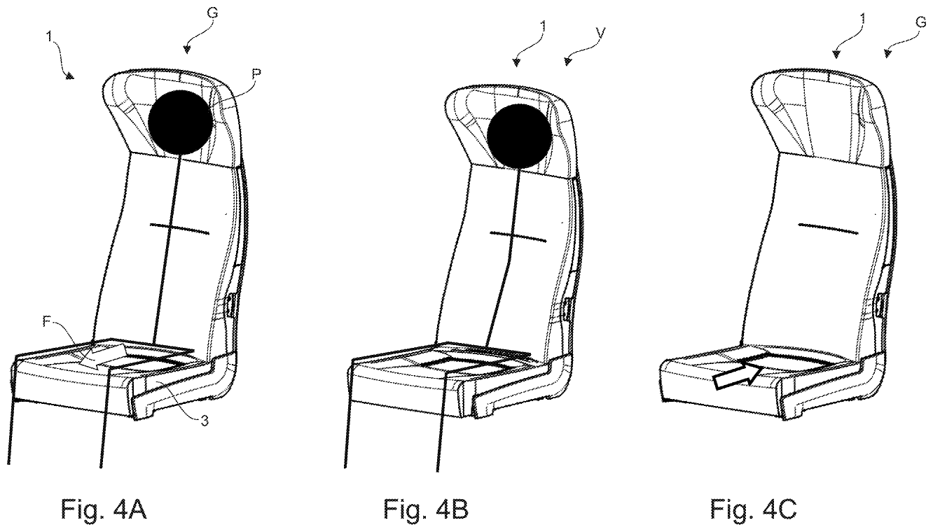

In FIGS. 4A to 4C, the functional principle according to the invention is illustrated by means of schematic drawings.

A person P sits on the vehicle seat 1, or more precisely the person P sits on the seat part 3. A force F, which acts on the seat part 3, can be applied by the person P in order to bring the vehicle seat 1 from the currently present basic position G of the vehicle seat 1 into a displaced position V, which is shown in FIG. 4B. The seat part 3 is displaced in the same way as in FIG. 4A.

For this purpose, the vehicle seat 1 is formed and provided such that the seat part 3 can be held in the displaced position V by a weight of the person P sitting on the seat part 3.

When the person P leaves the vehicle seat 1, i.e. stands up, it is envisaged in accordance with the invention that the seat part 3 is displaced from the displaced position V to the basic position G by the restoring element 5. The action of the restoring element 5 is shown by the arrow of FIG. 4C, which indicates the movement of the seat part 3.

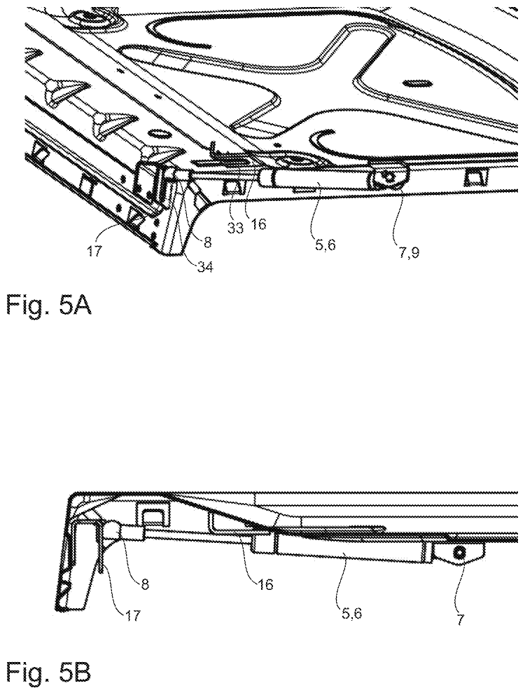

The restoring element 5 and the further embodiment according to a preferred embodiment of the seat part 3 is shown in more detail in FIGS. 5A and 5B.

As shown, the restoring element 5 has a first end 7 and a second end 8. Preferably, the restoring element 5 is a gas spring element 6. The first end 7 is connected to the seat part 3 and the second end 8 is connected to the seat part frame 2, whereby the seat part frame 2 is not shown here.

When the seat part 3 is displaced relative to the seat part frame 2, the arrangement of the ends 7, 8 causes the ends 7, 8 to move relative to one another so that the gas spring element 6 is actuated. In the basic position G, the gas spring element 6 is substantially relaxed in the basic position G and compressed in the displaced position V, so that the gas spring element 6 tends to relax. However, due to the weight of the person P, this is not possible because the extension force of the gas spring element 6 is too low.

Further shown is the first end stop 16, which is preferably formed by an L-shaped element. Along the L-shape extends an oblong hole 33, which is formed and provided to interact with the bolt element 18. The L-shaped configuration of the oblong hole 33 allows the bolt element 18 to thread into the oblong hole 33 when it is displaced forward.

Furthermore, a second end stop 17 is preferably also shown, which has a dual function. The first function consists in guiding the second end 8 along the height direction H. This is particularly helpful during assembly or disassembly. The second function is the end stop of the movement with respect to the reset, i.e. in case of a backward displacement. The relaxation of the restoring element 5 can be limited by this.

According to one embodiment, the second end stop 17 can be U-shaped and have an L-shaped oblong hole 34, by means of which the second end 8 can be guided. Such a guide is particularly useful during assembly, as it ensures good pre-positioning of the restoring element 5 during assembly, good releasability and prevention of the second end 8 from falling down during assembly and disassembly.

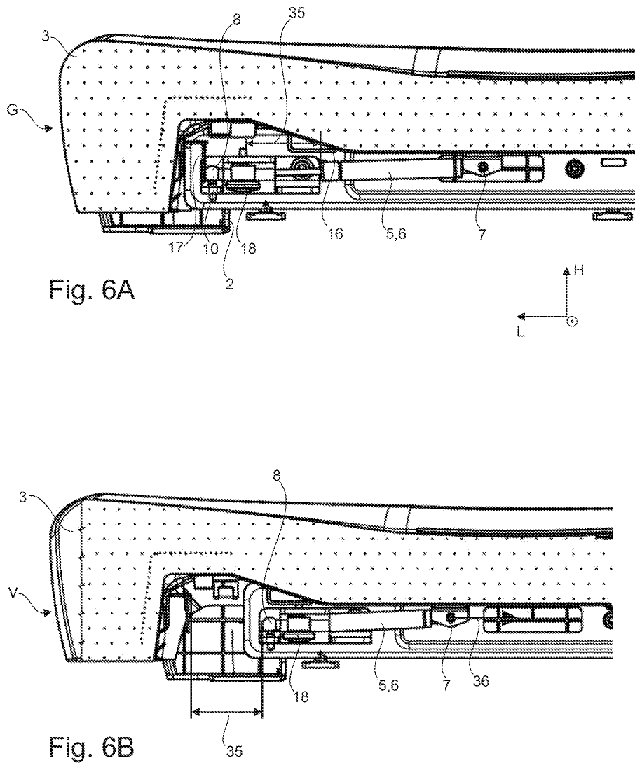

In FIGS. 6A and 6B, the operating principle of the present invention is again illustrated in more detail. Thus, FIG. 6A shows the basic position G and FIG. 6B shows the displaced position V.

According to FIG. 6A, which shows the basic position G of the vehicle seat 1 or of the seat part 3, the second end 8 of the restoring element 5 is in contact with the second end stop 17. Further, the bolt element 18 is arranged at a first distance 35 from the end of the oblong hole 33, so that the first distance 35 corresponds to the maximum displacement travel of the seat part 3.

The restoring element 5, in this case the gas spring element 6, is substantially relieved of tension. A slight tension is present in that the second end 8 contacts the second end stop 17 and the distance between the first end 7 and the second end 8 does not fully correspond to the maximum distance between the ends 7, 8. Preferably, it can be provided that the first end 7 is also rotatably connected to the seat part 3 by means of a first spherical head element 9.

If the seat part 3 is now displaced forwards, for example into the maximum displaced position V according to FIG. 6B, the bolt element 18 now contacts the oblong hole 33 and is limited in its displacement by the latter. The second end 8 is now released from the second end stop 17. The second end 8 is displaced in the direction of the first end 7 of the restoring element 5, so that in this case the restoring element 5 is compressed and generates a counterforce which acts in the opposite direction to the displacement; this is represented by the arrow 36, which represents the counterforce 36.

In this case, the counterforce 36, in particular the maximum counterforce 36, is smaller than the counterforce of a person P, in particular also if the person P is a child. The seat part 3 is therefore held in the respective displaced position V by the counterforce.

If the person P now stands up and leaves the seat part 3, the weight of the person P no longer acts on the seat part 3 and the counterforce 36 displaces the seat part 3 from the displaced position V to the home position G.

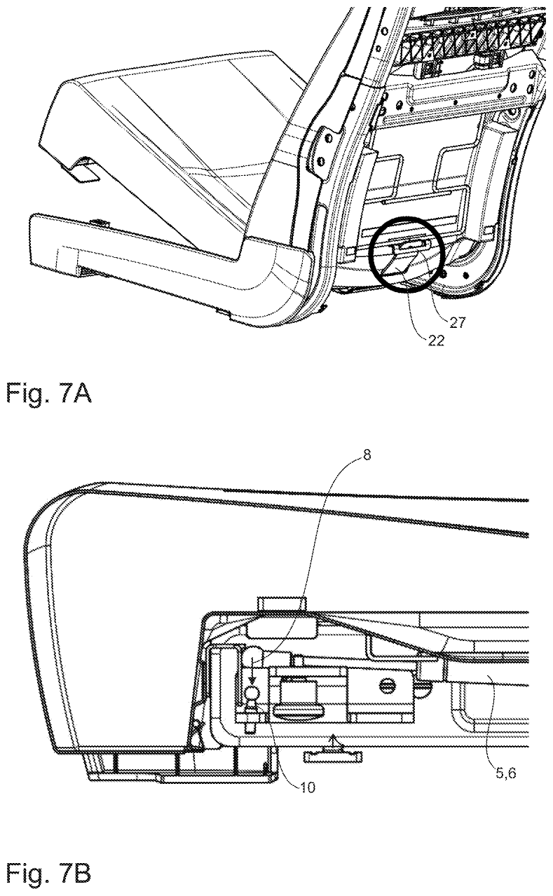

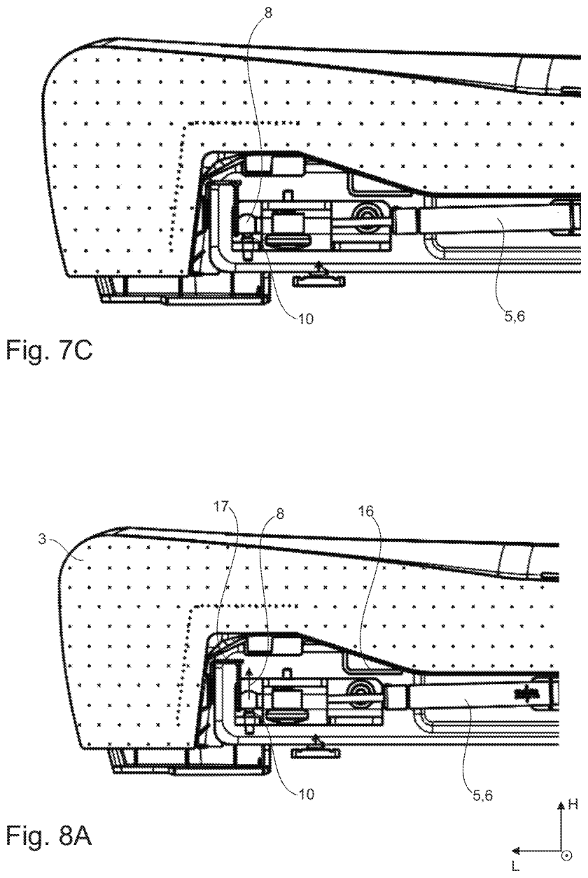

FIGS. 7A to 7C still schematically describe the assembly procedure.

Here, the seat part 3 and the seat part frame 2 are initially present as separate parts, as shown in FIGS. 2A and 2B.

The seat part 3 and the seat part frame 2 are now assembled according to the present embodiment, as follows.

First, the seat part 3 is set at an angle and the mounting element 22 of the seat part 3 is inserted or hooked into a corresponding mounting support 37 of the backrest 19. Further, the seat part 3 is then connected to the sliding block elements 11 via the mounting sections 28 of the slots 12 by bringing the seat part 3 into a horizontal position.

In this case, the first end stop 16 is located in front of the bolt element 18, as seen in the longitudinal direction L, the bolt element 18 not being arranged to engage in the first end stop 16, so that, in order to set the basic position G, the bolt element 18 is displaced downwards in a height direction H, the seat part 3 is then displaced backwards in the longitudinal direction L until the bolt element 18 can engage in the first end stop 16, and the bolt element 18 is displaced upwards in the height direction H and contacts the first end stop 16.

The seat part 3 is therefore in the basic position G. Next, the second end 8 is connected to the second ball head element 10 by displacing the second end 8 downward along the height direction H and connecting it to the second spherical head element 10. This is illustrated in FIG. 7B.

The assembled state of the vehicle seat 1 is shown in FIG. 7C.

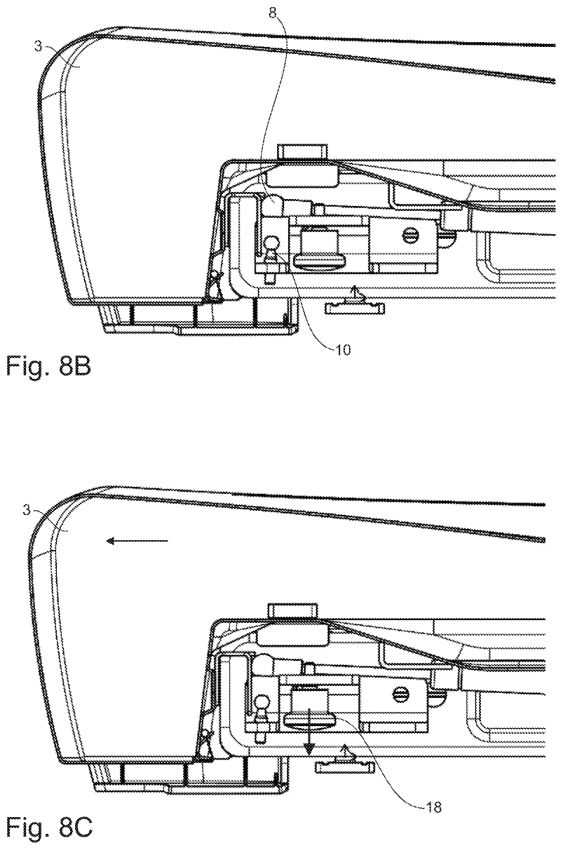

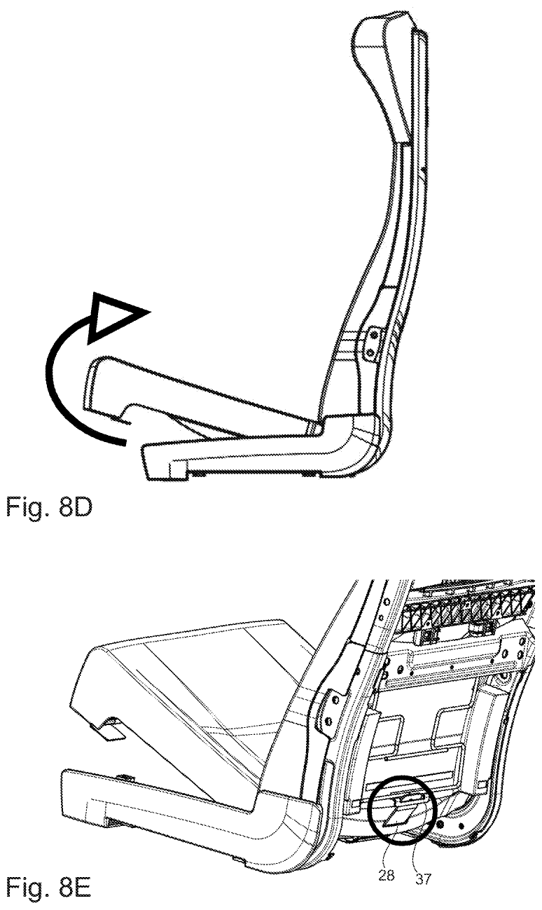

The further FIGS. 8A to 8E show the disassembly of the seat part 3 from the seat part frame 2.

In a first step, shown in FIG. 8A, the second end 8 is disengaged from the second ball head element 10 and displaced upwards so that the seat part 3 and the seat part frame 2 are forcefully decoupled, since the restoring element 5 is now exclusively connected to the seat part 3. This is shown in FIG. 8B.

In order to now release the further connection between seat part 3 and seat part frame 2, namely the slot nut guide, it is provided that the seat part 3 is moved forward and at the same time simultaneously the bolt element 18 is displaced downward, so that the seat part 3 can be displaced beyond the first end stop 16 in order to displace the respective sliding block 11 into the mounting section 28 of the associated slot 12. This is illustrated in FIG. 8C.

If this is the case, then the seat part 3 can be inclined, as shown in FIG. 8D, causing the sliding block elements 11 and the slots 12 to separate from each other. Further, it is necessary to rotate the seat part 3 until the mounting element 22 is also guided out of the mounting support 37 and a connection between the mounting element 22 and the mounting support 37 is no longer possible. The seat part 3 can then be removed. These steps are illustrated in FIGS. 8D and 8E.

All features disclosed in the application documents are claimed to be essential to the invention insofar as they are individually or in combination new compared to the prior art.

### LIST OF REFERENCE SIGNS

1 Vehicle seat
2 Seat part frame
3 Seat part
4 Guiding device
5 Restoring element
6 Gas spring element
7 First end of the return element
8 Second end of the return element
9 First ball head element
10 Second ball head element
11 sliding block
12 Slot
13 First section
14 Second section
15 Third section
16 First end stop
17 Second end stop
18 Bolt element
19 Backrest
20 Armrest
21 Headrest
22 Mounting element
23 First cover element
24 Second cover element
25 First width
26 Second width
27 Third width
28 Mounting section
29 First retaining element
30 First leg
31 Second leg
32 Retaining part
33 Oblong hole
34 Oblong hole
35 First distance
36 Counterforce/arrow
37 Mounting support
F Force
G Home position
P Person
V Displaced position
B Width direction
L Longitudinal direction
H Height direction

What is claimed is:

1. A vehicle seat comprising:
a seat part frame; and
a seat part displaceable in relation to the seat part frame, wherein the seat part is guided on the seat part frame by means of a guide means,
wherein
the seat part can be displaced from a basic position to a displaced position in relation to the seat part frame by a force applied to the seat part, which is exerted on the seat part by a person sitting on the seat part, wherein the vehicle seat is formed and provided in such a way that the seat part can be held in the displaced position by a weight of the person sitting on the seat part, and wherein a restoring element is formed and provided to move the seat part from the displaced position to the basic position when the person leaves the seat part.

2. The vehicle seat according to claim 1,
wherein
the restoring element has a first end and a second end, wherein the first end is connected to the seat part and the second end is connected to the seat part frame, particular in a rotatable manner.

3. The vehicle seat according to claim 2,
wherein
the first end is connected to the seat part by means of a first spherical head element and/or the second end is connected to the seat part frame by means of a second spherical head element.

4. The vehicle seat according to claim 1,
wherein
the restoring element is formed by a gas spring element, wherein the gas spring element is substantially relaxed in the basic position and compressed in the displaced position.

5. The vehicle seat according to claim 1,
wherein
the guide means comprises sliding block elements and slots, wherein the sliding block are formed at least partially complementary to the slots, so that the sliding block can be guided in the slots.

6. The vehicle seat according to claim 5,
wherein
a sliding block element comprises a first section, a second section and a third section, wherein the first section is arranged above the slot and is formed wider than the slot, and wherein the second section is connected to the first section and extends through the corresponding slot and a third section is arranged below the slot and is connected to the second section, wherein the third section is also formed wider than the slot.

7. The vehicle seat according to claim 1,
wherein
a first end stop is arranged on the seat part and a bolt element is arranged on the seat part frame, which are provided and formed to interact with one another when the seat part is moved from the displaced position to the basic position, wherein the contact of the bolt element with the end stop defining the basic position.

8. The vehicle seat according to claim 2,
wherein
a second end stop is arranged on the seat part, wherein in the basic position the second end is in contact with the second end stop and in the displaced position the second end is released from the second end stop.

9. A method of assembling a vehicle seat without tools according to claim 1, comprising the process steps:
a) providing a seat part frame and a seat part, wherein a restoring element is connected to the seat part,
b) connecting the seat part frame and the seat part by means of the guide means;
c) connecting the first end of the restoring element to the seat part frame.

10. The method according to claim 9,
wherein
in the process step c) the first end is displaced in the height direction by means of the second end stop comprising a guiding slot, so that the first end can be connected to the seat part frame.

11. The method according to claim 9,
wherein
the first end stop according to the process step b), as seen in a longitudinal direction in front of the bolt and the bolt element is arranged so as not to interfere with the end stop, so that the bolt element has to be displaced downwards in a height direction in order to adjust to the basic position, the seat part is then displaced in the longitudinal direction until the bolt element can lock into in the end stop and the bolt element is displaced upwards in the height direction and the first end stop is contacted.
